(19) United States
(12) Patent Application Publication
(10) Pub. No.: US 2007/0134122 A1
(43) Pub. Date: Jun. 14, 2007

(54) Hydraulic pump

(76) Inventors: Chin-Tang Wang, Tainan City (TW); Ieng-Heong Lio, Hong Kong (HK)

Correspondence Address: CHRISTIE, PARKER & HALE, LLP, PO BOX 7068, PASADENA, CA, 91109-7068, US

(21) Appl. No.: 11/298,793

(22) Filed: Dec. 9, 2005

(51) Int. Cl. F01C 1/18; F01C 1/24; F03C 2/00

(52) U.S. Cl. 418/206.1; 418/205

(57) ABSTRACT

A hydraulic pump includes an outer housing unit formed with a fluid-moving chamber and a pressure relief passage. The fluid-moving chamber has a fluid entrance portion and a fluid exit portion. The pressure relief passage has an inlet communicated with the fluid exit portion, and an outlet communicated with a fluid-guiding seat disposed in the fluid entrance portion. A first gear is rotatable in a first direction to move fluid from the fluid entrance portion into the fluid exit portion. When the pressure in the fluid exit portion reaches a threshold pressure, a pressure relief valve is activated so as to return fluid from the fluid exit portion into the fluid entrance portion via the pressure relief passage. This results in injection of fluid from the fluid-guiding seat onto the first gear, thereby facilitating rotation of the first gear in the first direction.

### BACKGROUND OF THE INVENTION

1. Field of the Invention

This invention relates to a hydraulic pump, and more particularly to a hydraulic pump that moves fluid by means of a gear unit.

2. Description of the Related Art

Referring to FIGS. 1, 2, and 3, a conventional hydraulic pump 1 is adapted to force fluid from a fluid tank 11 into a rotatable object 12. The pump 1 includes an outer housing unit 13, a first gear 14, a driving unit 15, a second gear 16, and a pressure relief valve 17. The outer housing unit 13 has a fluid-moving chamber 131, a fluid entrance port 132 disposed between and communicated with the fluid-moving chamber 131 and the fluid tank 11, a fluid exit port 133 disposed between and communicated with the fluid-moving chamber 131 and the rotatable object 12, a pressure relief passage 134, and a pair of curved first and second gear-positioning surfaces 135, 136. The first gear 14 is disposed in the fluid-moving chamber 131 between the fluid entrance portion 132 and the fluid exit portion 133 of the fluid-moving chamber 131, and is adjacent to the first gear-positioning surface 135. The driving unit 15 drives the first gear 14 to rotate in a first (clockwise) direction. The second gear 16 is disposed in the fluid-moving chamber 131 between the fluid entrance portion 132 and the fluid exit portion 133 of the fluid-moving chamber 131, and meshes with the first gear 14. The pressure relief valve 17 is disposed in the pressure relief passage 134. The pressure relief passage 134 has an inlet 137 communicated with the fluid exit portion 133 of the fluid-moving chamber 131 and disposed below the first and second gears 14, 16, and an outlet 138 communicated with the fluid entrance portion 132 of the fluid-moving chamber 131 and disposed above the first and second gears 14, 16.

During use, when the driving unit 15 is actuated to rotate the first gear 14 in the first direction and, thus, the second gear 16 in a second (counterclockwise) direction, fluid flows from the fluid entrance portion 132 into the fluid exit portion 133 via a first space 141 located between the first gear 14 and the first gear-positioning surface 135, and a second space 161 located between the second gear 16 and the second gear-positioning surface 136. When the pressure in the fluid exit portion 133 of the fluid-moving chamber 131 reaches a threshold pressure, the pressure relief valve 17 is activated so as to allow for return flow of fluid from the fluid exit portion 133 of the fluid-moving chamber 131. It would be desirable to have increased functionality of the fluid returned from the fluid exit portion 133 into the fluid entrance portion 132.

### SUMMARY OF THE INVENTION

The object of this invention is to provide a hydraulic pump that includes a gear unit for moving fluid, and a fluid-guiding seat cooperating with a pressure relief passage so as to facilitate rotation of the gear unit.

According to this invention, a hydraulic pump includes an outer housing unit formed with a fluid-moving chamber and a pressure relief passage. The fluid-moving chamber has a fluid entrance portion and a fluid exit portion. The pressure relief passage has an inlet communicated with the fluid exit portion, and an outlet communicated with a fluid-guiding seat disposed within the fluid entrance portion. A first gear is rotatable in a first direction to move fluid from the fluid entrance portion to the fluid exit portion. When the pressure in the fluid exit portion reaches a threshold pressure, a pressure relief valve is activated so as to return fluid from the fluid exit portion into the fluid entrance portion via the pressure relief passage. This results in injection of fluid from the fluid-guiding seat onto the first gear, thereby facilitating rotation of the first gear in the first direction. As such, the load of the driving unit can be reduced.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a top view of a conventional hydraulic pump;

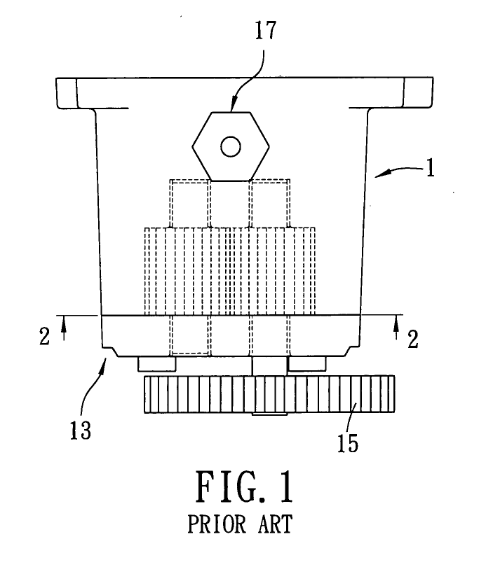

FIG. 2 is a sectional view taken along Line 2-2 in FIG. 1;

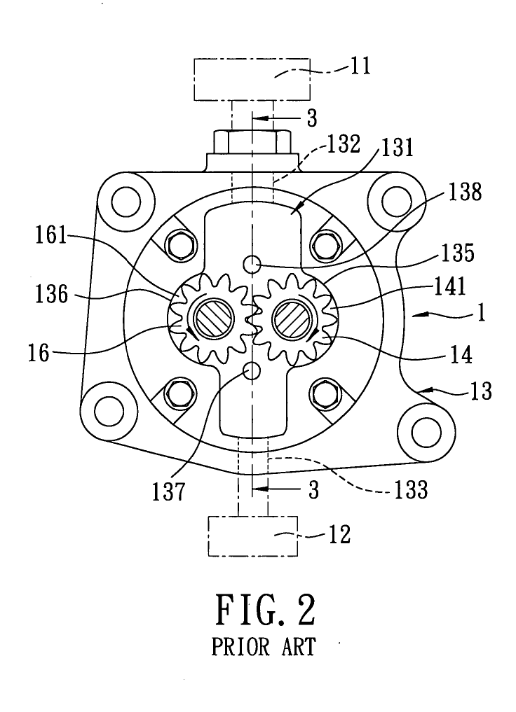

FIG. 3 is a sectional view taken along Line 3-3 in FIG. 2;

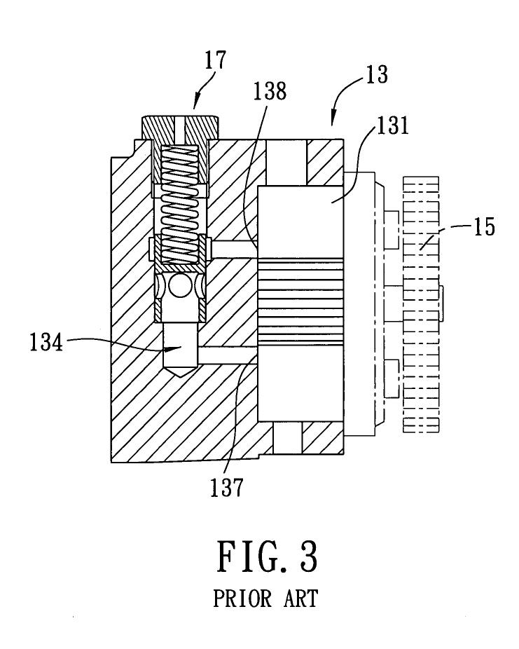

FIG. 4 is a fragmentary, partly sectional front view of the preferred embodiment of a hydraulic pump according to this invention, in which an end cap and a driving unit are removed;

FIG. 5 is a fragmentary exploded perspective view of a fluid-moving mechanism and a fluid-guiding seat of the preferred embodiment;

FIG. 6 is a sectional side view of the preferred embodiment, illustrating a non-relief position of a pressure relief valve;

FIG. 7 is a fragmentary schematic sectional view of the preferred embodiment, illustrating arrangement among first and second gears, an inlet of a pressure relief passage, and a fluid-guiding seat; and

FIG. 8 is a sectional side view of the preferred embodiment, illustrating a relief position of the pressure relief valve.

### DETAILED DESCRIPTION OF THE PREFERRED EMBODIMENT

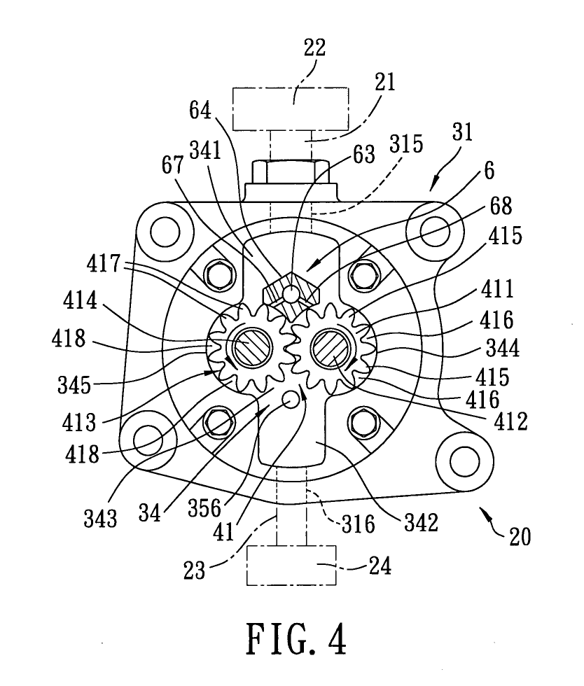

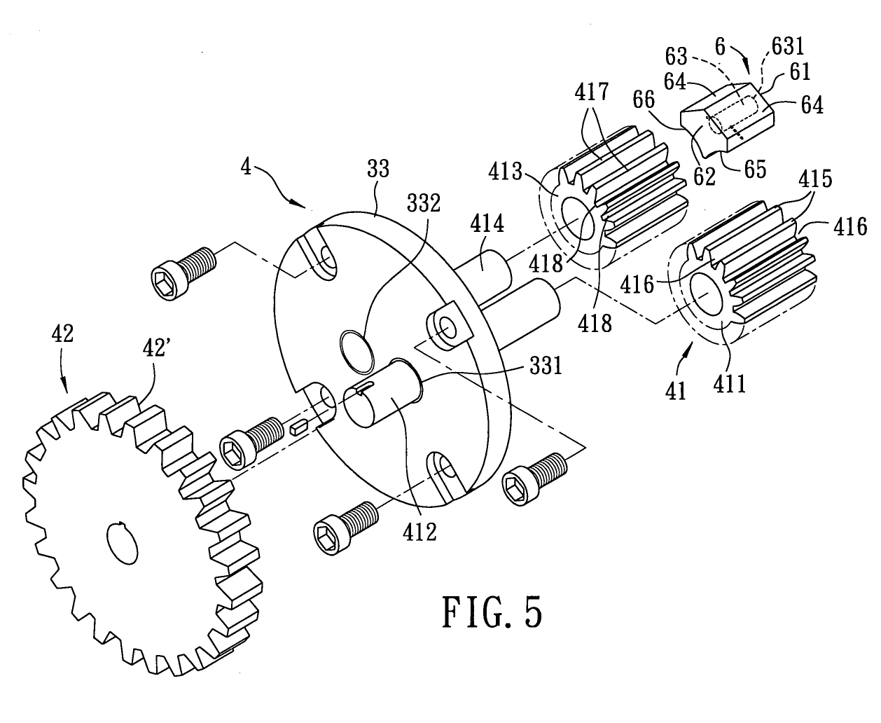

Referring to FIGS. 4, 5, and 6, the preferred embodiment of a hydraulic pump 20 according to this invention is connected to a fluid tank 22 by means of an input tube 21, and to a rotatable object 24 by an output tube 23. Fluid can be forced to flow from the fluid tank 22 into the rotatable object 24 through the input tube 21 and the output tube 23 by the hydraulic pump 20. The hydraulic pump 20 includes an outer housing unit 3, a fluid-moving mechanism 4, a pressure relief valve 5, and a fluid-guiding seat 6.

The outer housing unit 3 includes a housing member 31 and an end cap 33 connected fixedly to the housing member 31 by bolts 32. The housing member 31 has an abutment surface 313 abutting against the end cap 33, an annular surrounding surface 314 extending from an outer periphery of the abutment surface 313, a fluid-moving chamber 34 formed in the abutment surface 313, a fluid entrance port 315 disposed between and communicated with the input tube 21 and the fluid-moving chamber 34, and a fluid exit port 316 disposed between and communicated with the output tube 23 and the fluid-moving chamber 34. Fluid is fed into the fluid-moving chamber 34 through the fluid entrance port 315.

The end cap 33 has a pair of first and second axial holes 331, 332 formed therethrough. The fluid-moving chamber 34 has a fluid entrance portion 341 disposed in proximity to the fluid entrance port 315, a fluid exit portion 342 disposed in proximity to the fluid exit port 316, and a gear-receiving portion 343 disposed between the fluid entrance portion 341 and the fluid exit portion 342. The gear-receiving portion 343 is defined by a pair of curved first and second gear-positioning surfaces 344, 345, which are disposed respectively around the first and second axial holes 331, 332 in the end cap 33.

A pressure relief passage 35 is formed in the housing member 31, and includes an elongated valve chamber 351 extending along a radial direction of the housing member 31, an axial first passage portion 352, and an axial second passage portion 353. Each of the first and second passage portions 352, 353 extends along an axial direction of the housing member 31. The valve chamber 351 has an open end 354 formed in the surrounding surface 314, and a closed end 355 opposite to the open end 354. The first passage portion 352 is disposed between and communicated with the valve chamber 351 and the fluid exit portion 342 of the fluid-moving chamber 34, and has an inlet 356 communicated with the fluid exit portion 342. The second passage portion 353 is disposed between and communicated with the valve chamber 351 and the fluid entrance portion 341 of the fluid-moving chamber 34, and has an outlet 357 communicated with the fluid entrance portion 341 of the fluid-moving chamber 34.

The fluid-moving mechanism 4 includes a gear unit 41 disposed within the gear-receiving portion 343 of the fluid-moving chamber 34 of the outer housing unit 3, and a driving unit 42 for driving the gear unit 41. The gear unit 41 includes a first gear 411, a first rotating shaft 412 extending through the first axial hole 331 in the end cap 33 and permitting the first gear 411 to be sleeved fixedly thereon, a second gear 413 meshing with the first gear 411, and a second rotating shaft 414 extending through the second axial hole 332 in the end cap 33 and permitting the second gear 413 to be sleeved fixedly thereon. The first gear 411 has a plurality of ridges 415 and a plurality of valleys 416. The tips of the ridges 415 are disposed in proximity to the first gear-positioning surface 344. The second gear 413 also has a plurality of ridges 417 and a plurality of valleys 418. The tips of the ridges 417 are disposed proximity to the second gear-positioning surface 345. The driving unit 42 drives the first rotating shaft 412 and, thus, the first gear 411 to rotate within the fluid-moving chamber 34 in a first (clockwise) direction in a known manner, and includes a motor unit (not shown) and a speed reduction gear 42′. As such, when the driving unit 42 is actuated, the first and second gears 411, 413 can move fluid from the fluid entrance portion 341 of the fluid-moving chamber 34 into the fluid exit portion 342 of the fluid-moving chamber 34.

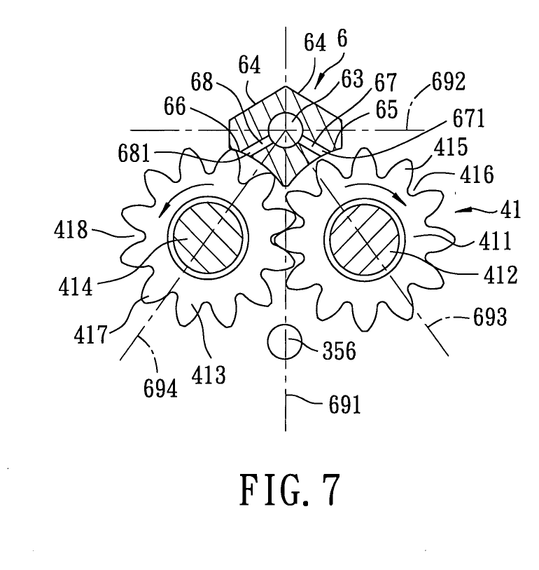

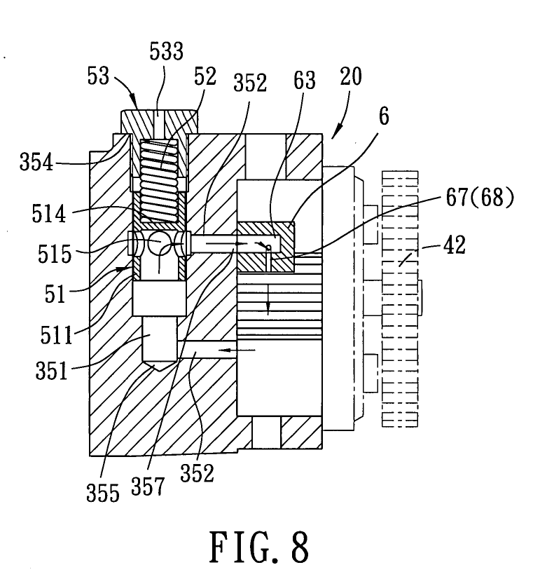

The pressure relief valve 5 is disposed in the valve chamber 351 of the pressure relief passage 35 in the outer housing unit 3, and includes a valve member 51, a spring 52 for biasing the valve member 51 to move, and an end retainer 53 disposed threadably within the open end 354 of the valve chamber 351. The spring 52 biases the valve member 51 toward the open end 354 of the valve chamber 351. The valve member 51 includes an annular surrounding wall 511 in slidable contact with an annular inner wall surface defining the valve chamber 351, a fluid passage chamber 512 disposed within a lower portion of the valve member 51, a spring-receiving chamber 513, and a partition 514 formed integrally with the surrounding wall 511 and disposed between the fluid passage chamber 512 and the spring-receiving chamber 513. The surrounding wall 511 has a plurality of pressure relief holes 515 formed therethrough and communicated with the fluid passage chamber 512. The valve member 51 is movable within the valve chamber 351 between a non-relief position shown in FIG. 7 and a relief position shown in FIG. 8. The end retainer 53 has a top wall portion 531 abutting against the surrounding surface 314, a hollow cylindrical spring-confining portion 532, and a fluid-discharging hole 533 formed through the top wall 531.

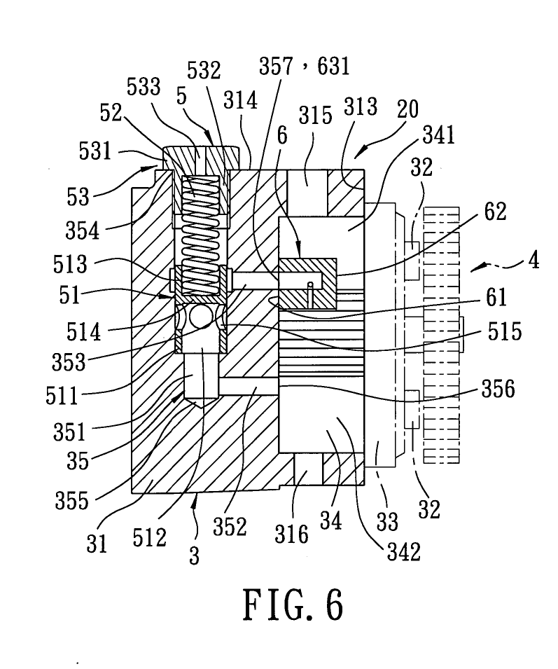

With additional reference to FIG. 7, the fluid-guiding seat 6 is disposed in the fluid entrance portion 341 of the fluid-moving chamber 34, and has a first end surface 61, a second end surface 62, a main passage 63, a pair of interconnected guiding surfaces 64, a pair of first and second curved surfaces 65, 66, and a pair of first and second branch passages 67, 68. The first end surface 61 is disposed in proximity to the outlet 357 of the pressure relief passage 35, as shown in FIG. 6. The second end surface 62 is opposite to and parallel to the first end surface 61, and is disposed in proximity to the end cap 32. The main passage 63 has an inlet 631 formed in the first end surface 61, and extends toward the second end surface 62. The guiding surfaces 64 are connected respectively to the first and second end surfaces 61, 62, and face the fluid entrance port 315 for guiding flow of fluid from the fluid entrance port 315 onto the first and second gears 411, 413, respectively. The first curved surface 65 faces and is adjacent to the first gear 411. The second curved surface 66 faces and is adjacent to the second gear 413. The first branch passage 67 is communicated with the main passage 63, and extends toward the first gear 411. Similarly, the second branch passage 68 is communicated with the main passage 63, and extends toward the second gear 413. The first and second branch passages 67, 68 respectively have spraying outlets 671, 681 formed respectively in the first and second curved surfaces 65, 66 and directed respectively toward the first and second gears 411, 413. As such, fluid can flow from the outlet 357 of the pressure relief passage 35 into the first and second branch passages 67, 68 via the main passage 63 so as to inject onto the first and second gears 411, 413. The main passage 63 has a cross section greater that of each of the first and second branch passages 67, 68.

The first and second curved surfaces 65, 66 are located to two opposite sides of an imaginary reference line 691 interconnecting the central axis of the main passage 63 and the center of the inlet 356 of the pressure relief passage 35. An imaginary perpendicular line 692 is perpendicular to and intersects the reference line 691 at the central axis of the main passage 63. An imaginary first inclined line 693 interconnects the central axis of the main passage 63 and the rotating axis of the first gear 411. An imaginary second inclined line 694 interconnects the central axis of the main passage 63 and the rotating axis of the second gear 413. The guiding surfaces 64 are located to two opposite sides of the reference line 691, and are respectively parallel to the first and second branch passages 67, 68. Fluid is injected from the first branch passage 67 onto the first gear 411 at a position between the perpendicular line 692 and the first inclined line 693, and from the second branch passage 68 onto the second gear 413 at a position between the perpendicular line 692 and the second inclined line 694.

During use, when the driving unit 42 is actuated, the first gear 411 rotates clockwise, while the second gear 413 rotates counterclockwise. Thus, fluid is moved from the fluid entrance portion 341 of the fluid-moving chamber 34 into the fluid exit portion 342 of the fluid-moving chamber 34 via a first space located between the first gear 411 and the first gear-positioning surface 344, and a second space located between the second gear 413 and the second gear-positioning surface 345.

When fluid flows from the fluid entrance portion 341 into the fluid exit portion 342, the pressure in the fluid exit portion 342 increases. When the pressure in the fluid exit portion 342 of the fluid-moving chamber 34 reaches a threshold pressure, the valve member 51 moves in the valve chamber 351 against the biasing force of the spring 52 to align the pressure relief holes 515 with the second passage portion 353 of the pressure relief passage 35. Therefore, fluid flows the fluid exit portion 342 of the fluid-moving chamber 34 into the fluid-guiding seat 6 via the pressure relief passage 35. Hence, fluid is injected from the first and second branch passages 67, 68 onto the first and second gears 411, 413. This facilitates clockwise rotation of the first gear 411 and counterclockwise rotation of the second gear 413. Due to the presence of the fluid-guiding seat 6, the load of the driving unit 42 is reduced.

During movement of the valve member 51, fluid may flow into a space located between the valve member 51 and the end retainer 53 via a space located between the surrounding wall 511 of the valve member 51 and the annular inner wall surface defining the valve chamber 351. If the space located between the valve member 51 and the end retainer 53 is filled with fluid, the spring 52 may be unable to undergo compression. However, the fluid-discharging hole 533 can prevent the space located between the valve member 51 and the end retainer 53 from being filled with fluid. With this invention thus explained, it is apparent that numerous modifications and variations can be made without departing from the scope and spirit of this invention. It is therefore intended that this invention be limited only as indicated by the appended claims.

We claim:

1. A hydraulic pump comprising:
an outer housing unit formed with a fluid-moving chamber and a pressure relief passage, said fluid-moving chamber having a fluid entrance portion, a fluid exit portion, and a gear-receiving portion disposed between said fluid entrance portion and said fluid exit portion, said pressure relief passage having an inlet communicated with said fluid entrance portion, and an outlet;
a fluid-moving mechanism including
a gear unit mounted within said gear-receiving portion of said fluid-moving chamber and including a first gear disposed rotatably in said fluid-moving chamber, and
a driving unit for rotating said first gear within said fluid-moving chamber in a first direction so as to move fluid from said fluid entrance portion of said fluid-moving chamber into said fluid exit portion of said fluid-moving chamber;
a pressure relief valve disposed in said pressure relief passage in said outer housing unit so as to allow for return flow of fluid from said fluid exit portion of said fluid-moving chamber into said fluid entrance portion of said fluid-moving chamber via said pressure relief passage when fluid pressure in said fluid exit portion of said fluid-moving portion reaches a threshold pressure; and
a fluid-guiding seat disposed in said fluid entrance portion of said fluid-moving chamber and having a main passage communicated with said outlet of said pressure relief passage, and a first branch passage communicated with said main passage and extending toward said first gear so as to allow fluid to flow from said outlet of said pressure relief passage into said first branch passage via said main passage, thereby injecting onto said first gear when said pressure in said fluid exit portion of said fluid-moving chamber in said outer housing unit reaches the threshold pressure, injection of fluid from said first branch passage onto said first gear facilitating rotation of said first gear in the first direction.

2. The hydraulic pump as claimed in claim 1, wherein
said gear unit further includes a second gear disposed within said gear-receiving portion of said fluid-moving chamber in said outer housing unit and meshing with said first gear so as to rotate in a second direction opposite to said first direction when said first gear rotates in said first direction, and
said fluid-guiding seat further has a second branch passage communicated with said main passage and extending toward said second gear so as to inject fluid onto said second gear, injection of fluid from said second branch passage onto said second gear facilitating rotation of said second gear in said second direction.

3. The hydraulic pump as claimed in claim 2, wherein said main passage in said fluid-guiding seat has a cross section greater than that of each of said first and second branch passages in said fluid-moving seat.

4. The hydraulic pump as claimed in claim 1, wherein
an imaginary reference line interconnects a central axis of said main passage in said fluid-guiding seat and a center of said inlet of said pressure relief passage in said outer housing unit;
an imaginary perpendicular line is perpendicular to and intersects the reference line at the central axis of said main passage;
an imaginary first inclined line interconnects the central axis of said main passage in said fluid-moving seat and a rotating axis of said first gear;
an imaginary second inclined line interconnects the central axis of said main passage in said fluid-moving seat and a rotating axis of said second gear;
fluid is injected from said first branch passage in said fluid-guiding seat onto said first gear at a position between the perpendicular line and the first inclined line, and from said second branch passage in said fluid-guiding seat onto said second gear at a position between the perpendicular line and the second inclined line.

5. The hydraulic pump as claimed in claim 4, wherein said outer housing unit is further formed with a fluid entrance port communicated with said fluid-moving chamber, fluid being fed into said fluid-moving chamber through said fluid entrance port, said fluid-guiding seat including:
a first end surface disposed in proximity to said outlet of said pressure relief passage in said outer housing unit, said main passage having an inlet formed in said first end surface;
a second end surface opposite to and parallel to said first end surface; and
two interconnected guiding surfaces connected respectively to said first and second end surfaces and facing said fluid entrance port in said outer housing unit for guiding flow of fluid from said fluid entrance port onto said first and second gears, respectively.

6. The hydraulic pump as claimed in claim 5, wherein said guiding surfaces of said fluid-guiding seat are located to two opposite sides of the reference line, and are respectively parallel to said first and second branch passages.

7. The hydraulic pump as claimed in claim 5, wherein said fluid-guiding seat further has first and second curved surfaces located to two opposite sides of the reference line and respectively facing and adjacent to said first and second gears, said first and second branch passages in said fluid-guiding seat having respectively spraying outlets that are formed respectively in said first and second curved surfaces and that direct respectively fluid toward said first and second gears.

8. The hydraulic pump as claimed in claim 1, wherein said outer housing unit is further formed with a fluid entrance port communicated with said fluid-moving chamber, fluid being fed into said fluid-moving chamber through said fluid entrance port, said fluid-guiding seat including:
a first end surface disposed in proximity to said outlet of said pressure relief passage in said outer housing unit, said main passage having an inlet formed in said first end surface;
a second end surface opposite to and parallel to said first end surface; and
two interconnected guiding surfaces connected respectively to said first and second end surfaces and facing said fluid entrance port in said outer housing unit for guiding flow of fluid from said fluid entrance port onto said first and second gears, respectively.
